(19) United States
(12) Patent Application Publication
(10) Pub. No.: US 2015/0300777 A1
(43) Pub. Date: Oct. 22, 2015

(54) GUN HOLSTER SYSTEM

(71) Applicant: Stephanie Ann Stalker, Lawrenceville, GA (US)

(72) Inventor: Stephanie Ann Stalker, Lawrenceville, GA (US)

(21) Appl. No.: 14/692,845

(22) Filed: Apr. 22, 2015

Related U.S. Application Data
(60) Provisional application No. 61/982,646, filed on Apr. 22, 2014.

(51) Int. Cl. F41C 33/04; F16M 11/22; A45C 13/02; F16M 11/04

(52) U.S. Cl. CPC F41C 33/048; F16M 11/041; F16M 11/22; A45C 13/02

(57) ABSTRACT

Implementations of a gun holster system are provided. In some implementations, the gun holster system allows a handgun to be securely stored and positioned within an interior opening of a handbag and/or purse. In some implementations, a gun holster system may comprise a base member and a holster configured to receive a handgun therein. In some implementations, the base member may rest against the bottom of a handbag when secured therein. In some implementations, the holster may comprise a first side piece and a second side piece. In some implementations, an opening is formed between a top edge of the first side piece and a top edge of the second side piece. In this way, a handgun secured within the holster may be pulled up through the opening formed between the top edge of the first side piece and the top edge of the second side piece.

### CROSS REFERENCE TO RELATED APPLICATION

This application claims the benefit of U.S. Patent Application Ser. No. 61/982,646, which was filed on Apr. 22, 2014, and is incorporated herein by reference in its entirety.

### TECHNICAL FIELD

This disclosure relates to implementations of a gun holster system.

### BACKGROUND

Weapons such as handguns are routinely carried in holsters designed to protect the handgun and hold it securely in place. Typically a handgun holster is worn on a belt at the waist, on the thigh, under an arm, and/ or around an ankle. Many users find it uncomfortable to carry a handgun in one of these positions on the body. As a result many users, women in particular, are now interested in holsters designed to facilitate carrying a handgun off body in, for example, a handbag or purse.

Unfortunately, prior art holster designs configured to be worn on a belt at the waist, on the thigh, under an arm, and/or around an ankle are generally not suitable for use within a purse as they provide no way of positioning the handgun for a quick and easy draw. In response, purses configured to act as a handgun holster have been developed.

However, these purses have several disadvantages. First, the selection of purses configured to act as a handgun holster is limited. Second, these designs do not allow a user to carry a handgun within a purse they currently own or one produced by a different designer. Third, many of these purse designs are unattractive and expensive.

### BRIEF DESCRIPTION OF THE DRAWINGS

FIG. 1 illustrates a side view of an example gun holster system according to the present disclosure.

FIG. 2A illustrates is rear perspective view of another example gun holster system according to the present disclosure.

FIG. 2B illustrates a side view of the gun holster system shown in FIG. 2A.

FIG. 2C illustrates a rear view of the gun holster system shown in FIG. 2A.

### DETAILED DESCRIPTION

Implementations of a gun holster system are provided. In some implementations, the gun holster system allows a handgun to be securely stored and positioned within an interior opening of a handbag and/or purse. In some implementations, a gun holster system may comprise a base member and a holster configured to receive a handgun therein. In some implementations, the holster may be removably secured directly to the base member. In some implementations, the holster may be removably secured to a vertical support member extending from the base member.

In some implementations, the base member may rest against the bottom of a handbag when secured therein. In some implementations, the base member may be configured to act as a base shaper.

In some implementations, the holster may comprise a first side piece and a second side piece. In some implementations, the first side piece and the second side piece may be configured to secure about a first side and a second side, respectively, of a handgun. In some implementations, an opening is formed between a top edge of the first side piece and a top edge of the second side piece. In this way, a handgun secured within the holster may be pulled up through the opening formed between the top edge of the first side piece and the top edge of the second side piece.

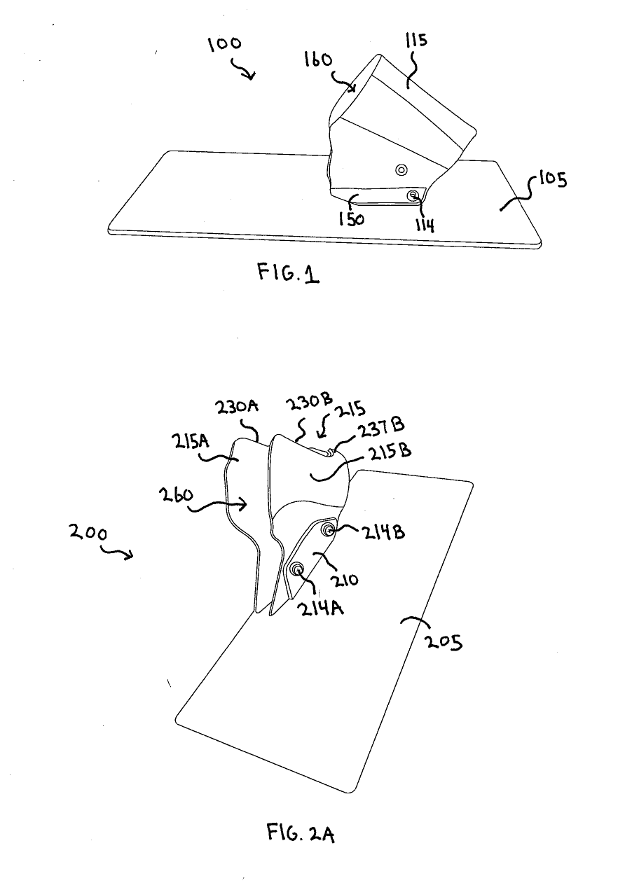

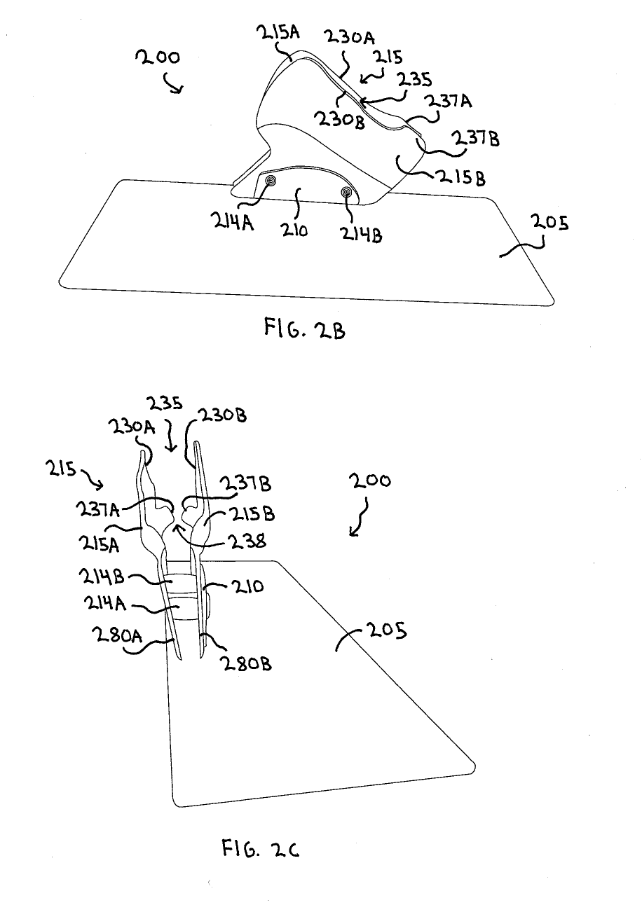

FIGS. 1 & 2A-2C illustrate example gun holster systems 100 (see, e.g., FIGS. 1) and 200 (see, e.g., FIGS. 2A-2C) according to the present disclosure. In some implementations, the gun holster system 100, 200 allows a handgun to be securely stored within a handbag and/or purse. In some implementations, the gun holster system 100, 200 positions (or cants) a handgun at a predetermined angle. In this way, when the gun holster system 100, 200 is positioned within a purse the user may easily draw the handgun therefrom. In some implementations, the gun holster system 100 may be configured to position a handgun at a fixed location within a purse. In this way, the handgun is not freely moving within the purse and is positioned to be easily drawn by the user. In some implementations, the gun holster system 200 may be configured so that a handgun secured with the holster may be pulled up through an opening between the sides of the holster (see, e.g., FIG. 2C).

As shown in FIGS. 1 & 2A-2C, in some implementations, a gun holster system 100 (see, e.g., FIGS. 1) and 200 (see, e.g., FIG. 2) may comprise a base member 105, 205, respectively, and a holster 115, 215, respectively. In some implementations, the holster 115 may be removably secured directly to the base member 105 (see, e.g., FIG. 1). In some implementations, the holster 215 may be removably secured to a vertical support member 210 extending from the base member 205 (see, e.g., FIG. 2A).

As shown in FIGS. 1 and 2A, in some implementations, the base member 105, 205 of the gun holster system may be a generally planar piece of material. In some implementations, the base member 105, 205 may be comprised of two or more layers of material. In some implementations, the base member 105, 205 may have rounded edges (see, e.g., FIGS. 1 and 2A). In this way, the base member 105, 205 may not damage the interior of a handbag when positioned therein. In some implementations, the base member 105, 205 may have square edges. In some implementations, the base member 105, 205 may be shaped like a rectangle (see, e.g., FIG. 2A). In some implementations, the base member 105, 205 may be shaped like a square. In some implementations, the base member 105, 205 may be any shape suitable for being received within an interior portion of a handbag.

In some implementations, the base member 105, 205 may be configured to fit within an interior opening of a handbag. In some implementations, the base member 105, 205 may rest against the bottom of a handbag when secured therein. In some implementations, the base member may be secured to an interior portion of a handbag using hook and loop fasteners (e.g., Velcro®). In some implementations, the base member may include fastening means such as snaps, buttons, magnets or other reclosable fasteners or any other attachment or fastening technology existing or developed in the future to secure the base member 105, 205 to an interior surface of a handbag (e.g., the bottom of a handbag). In some implementations, the base member 105, 205 may not be secured to any portion of a handbag or purse. In some implementations, the base member 105, 205 may be configured to act as a base shaper. In this way, the base member 105, 205 may prevent the handbag from sagging and/or deforming from the combined weight of a handgun and a gun holster system 100, 200.

As shown in FIGS. 1 & 2A-2C, in some implementations, the holster 115, 215 may be configured to receive and/or secure a handgun therein. In some implementations, the holster 115, 215 may be configured to secure about a portion of a handgun received thereon (e.g., the trigger guard and/or a portion of the slide and/or frame).

As shown in FIG. 1, in some implementations, the holster 115 may be removably secured to the base member 105 through the use of one or more rivets 114. In some implementations, the bottom of the holster 115 may have a flange 150 extending from a right (see, e.g., FIG. 1) and/or left side (not shown) thereof. In some implementations, one or more rivets 114 may be used to secure the flange 105 to the base member 105. In this way, the user may attach a holster 115 suitable for carrying the make and model of handgun that they prefer to the base member 105. In some implementations, a holster configured to receive therein more than one make and/or model of handgun may be used.

As shown in FIGS. 2A & 2B, in some implementations, the holster 215 may be removably secured to the support member 210 extending from the base member 205 through the use of one or more rivets 214A, 214B. In this way, the user may attach a holster 215 that is suitable for carrying the make and model of handgun that they prefer to the base member 205. In some implementations, a holster configured to receive therein more than one make and/or model of handgun may be used.

In some implementations, the vertical support 210 may include multiple openings therethrough positioned at different angles relative to each other. In this way, the angle (or cant) of the holster 215 may be adjusted based on user preference and/or the dimensions of the handbag into which the gun holster system 200 is to be placed. In some implementations, the openings may be configured to position the holster 215 at any angle between 10 degrees and 90 degrees, inclusive of 10 and 90 degrees, relative to the base member 205. One of ordinary skill in the art having the benefit of the present disclosure would know how to configure the openings of the vertical support 210 for the purpose of adjusting the cant of a holster secured thereto.

In some implementations, a holster 115, 215 may be secured to the base member 105, 205, respectively, through the use of other fasteners or fastening technology known to one of ordinary skill in the art having the benefit of the present disclosure.

As shown in FIGS. 2A-2C, in some implementations, the holster 215 may comprise a first side piece 215A and a second side piece 215B. In some implementations, the first side piece 215A and the second side piece 215B may be configured to secure about a first side and a second side, respectively, of a handgun.

As shown in FIG. 2C, a bottom portion 280A, 280B of the first side piece 215A and the second side piece 215B, respectively, of the holster 215 may be secured together. In this way, the holster 215 may be secured about a handgun. In some implementations, the first side piece 215A and the second side piece 215B of the holster 215 may be secured together through the use of a first rivet 214A and a second rivet 214B (collectively rivets 214) (see, e.g., FIG. 2C). In some implementations, the rivets 214 may be used to pull the first side piece 215A and the second side piece 215B together. In this way, the rivets 214 may be used to retain a handgun between the first side piece 215A and the second side piece 215B of the holster 215.

As shown in FIG. 2C, in some implementations, an opening 235 is formed between a top edge 230A of the first side piece 215A and a top edge 230B of the second side piece 215B. In this way, a handgun secured within the holster 215 may be pulled up and through the opening 235 formed between the top edge 230A of the first side piece 215A and the top edge 230B of the second side piece 215B (see, e.g., FIG. 2B). By facilitating the handgun being drawn up through the opening 235 in the top side of the holster 215 the user may not need to pull the handgun rearwardly to draw it from the holster 215. This may allow the handgun holster system 200 to be used with purses having internal dimensions insufficient to allow a handgun to be drawn from prior art holster designs that include a closed top side.

As shown in FIGS. 2A-2C, in some implementations, the top edge 230A of the first side piece 215A and the top edge 230B of the second side piece 215B may each have a curved flange 237A, 237B, respectively, extending therefrom. In some implementations, the curved flanges 237 may extend towards each other (see, e.g., FIG. 2C). In some implementations, when a handgun is secured within the holster 215, each curved flange 237 may be configured to cover a portion of the muzzle and a portion of the slide and/or frame located adjacent the muzzle. In some implementations, an opening 238 extends between an interior edge of each curved flange 237 (see, e.g., FIG. 2C).

In some implementations, not shown, the curved flanges 237A, 237B may be joined together along their length. In this way, the curved flanges 237 form a connective arch which may be used to further secure the first side piece 215A and the second side piece 215B of the holster 215 together. In some implementations, the connective arch formed by the curved flanges 237 does not extend along more than 20% of the length of the top edge 230A of the first side piece 215A and the top edge 230B of the second side piece 215B. In this way, a handgun may still be drawn up through the top opening 235 of the holster 215.

In some implementations, a gun holster system 100, 200 constructed according to the present disclosure may be manufactured from Kydex® or other thermoplastic acrylic-polyvinyl chloride material. In some implementations, a gun holster system 100, 200 may be manufactured from a polymer. In some implementations, a gun holster system 100, 200 may be manufactured from any material, or combination of materials, suitable for use in the construction of a gun holster.

In some implementations, a handgun may be secured within a holster 115, 215 by inserting the muzzle of a handgun into an opening 160, 260 in the backside of the holster 115, 215 (see, e.g., FIGS. 1 and 2A). The handgun may be pressed into the holster 115, 215 until it may travel no farther forward

In some implementations, a handgun may be withdrawn from the holster 215 by grasping the grip of the handgun and thereby pulling the muzzle of the handgun rearwardly a distance sufficient to allow the muzzle to clear the curved flanges 237. Next, the handgun may be pulled up and through the opening 235 between the first side piece 215A and the second side piece 215B of the holster 215.

Reference throughout this specification to “an embodiment” or “implementation” or words of similar import means that a particular described feature, structure, or characteristic is included in at least one embodiment of the present invention. Thus, the phrase “in some implementations” or a phrase of similar import in various places throughout this specification does not necessarily refer to the same embodiment.

Many modifications and other embodiments of the inventions set forth herein will come to mind to one skilled in the art to which these inventions pertain having the benefit of the teachings presented in the foregoing descriptions and the associated drawings.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

While operations are depicted in the drawings in a particular order, this should not be understood as requiring that such operations be performed in the particular order shown or in sequential order, or that all illustrated operations be performed, to achieve desirable results.

1. A handgun holster system comprising:
a base member configured to fit within an interior opening of a handbag and rest on a bottom side thereof; and
a holster comprising a first side piece having a first top edge and a first bottom portion, a second side piece having a second top edge and a second bottom portion, and an opening located between the first top edge and the second top edge configured to allow at least a portion of a handgun to pass therethrough;
wherein the first bottom portion is secured to the second bottom portion of the holster thereby forming an opening in a backside thereof configured to receive at least a portion of a handgun therein.

2. The handgun holster system of claim 1, further comprising a vertical support extending from the base member, the holster is removably secured to the vertical support.

3. The handgun holster system of claim 1, wherein the first top edge has a first curved flange extending therefrom and the second top edge has a second curved flange extending therefrom.

4. The handgun holster system of claim 1, further comprising a connective arch extending between the first top edge and the second top edge of the holster, the connective arch is configured to only cover a portion of a slide and a frame of a handgun located adjacent the muzzle end of the handgun.

5. The handgun holster system of claim 4, wherein the connective arch does not extend along more than 20 percent of the length of both the first top edge and the second top edge of the holster.
